(19) United States
(12) Patent Application Publication
(10) Pub. No.: US 2021/0107676 A1
(43) Pub. Date: Apr. 15, 2021

(54) Aircraft Having an Aft Engine and Auxiliary Power Unit

(71) Applicant: General Electric Company, Schenectady, NY (US)

(72) Inventors: Arthur William Sibbach, Boxford, MA (US); Randy M. Vondrell, Cincinnati, OH (US); Andrew Breeze-Stringfellow, Montgomery, OH (US)

(21) Appl. No.: 16/599,430

(22) Filed: Oct. 11, 2019

(51) Int. Cl. B64D 41/00; B64D 15/04; F02K 3/06; F02C 7/32

(52) U.S. Cl. CPC B64D 41/00; B64D 15/04; F05D 2220/323; F02C 7/32; F05D 2220/50; F02K 3/06

(57) ABSTRACT

An aircraft extending between a forward end and an aft end is provided. The aircraft includes an auxiliary power unit positioned proximate the aft end of the aircraft, the auxiliary power unit having an auxiliary power unit inlet duct and an auxiliary power unit exhaust duct, and a boundary layer ingestion fan positioned proximate the aft end of the aircraft, the boundary layer ingestion fan having a support shaft, wherein the auxiliary power unit exhaust duct extends through a portion of the support shaft of the boundary layer ingestion fan.

### FIELD

The present subject matter relates generally to an aircraft propulsion system including an engine and auxiliary power unit located at an aft end of an aircraft.

### BACKGROUND

A conventional commercial aircraft generally includes a fuselage, a pair of wings, and a propulsion system that provides thrust. The propulsion system typically includes at least two aircraft engines, such as turbofan jet engines. Each turbofan jet engine is mounted to a respective one of the wings of the aircraft, such as in a suspended position beneath the wing, separated from the wing and fuselage. Such a configuration allows for the turbofan jet engines to interact with separate, freestream airflows that are not impacted by the wings and/or fuselage. This configuration can reduce an amount of turbulence within the air entering an inlet of each respective turbofan jet engine, which has a positive effect on a net propulsive thrust of the aircraft.

However, a drag on the aircraft including the turbofan jet engines, also has an effect on the net propulsive thrust of the aircraft. A total amount of drag on the aircraft, including skin friction, form, and induced drag, is generally proportional to a difference between a freestream velocity of air approaching the aircraft and an average velocity of a wake downstream from the aircraft that is produced due to the drag on the aircraft.

Systems have been proposed to counter the effects of drag and/or to improve an efficiency of the turbofan jet engines. For example, certain propulsion systems incorporate boundary layer ingestion systems to route a portion of relatively slow moving air forming a boundary layer across, e.g., the fuselage and/or the wings, into the turbofan jet engines upstream from a fan section of the turbofan jet engines.

Furthermore, in certain configurations, a gas turbine engine may be used to drive an electric generator. For example, the gas turbine engine may be an auxiliary power unit (APU) of an aircraft, the APU including an electric generator for generating electrical power for various systems of the aircraft.

### BRIEF DESCRIPTION

Aspects and advantages of the invention will be set forth in part in the following description, or may be obvious from the description, or may be learned through practice of the invention.

In one exemplary embodiment of the present disclosure, an aircraft extending between a forward end and an aft end is provided. The aircraft includes an auxiliary power unit positioned proximate the aft end of the aircraft, the auxiliary power unit having an auxiliary power unit inlet duct and an auxiliary power unit exhaust duct, and a boundary layer ingestion fan positioned proximate the aft end of the aircraft, the boundary layer ingestion fan having a support shaft, wherein the auxiliary power unit exhaust duct extends through a portion of the support shaft of the boundary layer ingestion fan.

In certain exemplary embodiments the aircraft includes a mixer in communication with the auxiliary power unit and the boundary layer ingestion fan such that the mixer receives and mixes a boundary layer airflow from the boundary layer ingestion fan and an auxiliary power unit exhaust flow from the auxiliary power unit exhaust duct.

In certain exemplary embodiments the aircraft includes a thermal insulation portion between the auxiliary power unit exhaust duct and the support shaft of the boundary layer ingestion fan.

In certain exemplary embodiments the boundary layer ingestion fan defines a central axis and includes a fan rotatable about the central axis and including a plurality of fan blades attached to a fan shaft; a nacelle encircling the plurality of fan blades; and a structural member extending from the support shaft of the boundary layer ingestion fan to the nacelle.

In certain exemplary embodiments the auxiliary power unit exhaust duct includes a bypass portion that extends to the nacelle through the structural member, wherein an auxiliary power unit exhaust flow through the bypass portion to the nacelle is configured to de-ice the nacelle.

In certain exemplary embodiments the aircraft includes a motor having a drive shaft offset from the fan shaft and a gear in communication with the drive shaft and the fan shaft to drive the boundary layer ingestion fan.

In certain exemplary embodiments the auxiliary power unit exhaust duct extends through a center of the support shaft of the boundary layer ingestion fan along an axial direction of the boundary layer ingestion fan.

In certain exemplary embodiments the boundary layer ingestion fan is incorporated into a tail section of the aircraft at the aft end of the aircraft.

In certain exemplary embodiments a portion of the boundary layer ingestion fan makes up the aft end of the aircraft.

In another exemplary embodiment of the present disclosure, an aircraft extending between a forward end and an aft end is provided. The aircraft includes an auxiliary power unit positioned proximate the aft end of the aircraft, the auxiliary power unit having an auxiliary power unit inlet duct and an auxiliary power unit exhaust duct; and an aft engine. The aft engine is configured to be mounted to the aircraft at the aft end, the aft engine defining a central axis and including a fan rotatable about the central axis of the aft engine and including a plurality of fan blades attached to a fan shaft; a nacelle encircling the plurality of fan blades; and a structural member extending from a portion of the aft engine to the nacelle, wherein the auxiliary power unit exhaust duct extends through the structural member to the nacelle.

In certain exemplary embodiments the aft engine includes a power source having a drive shaft and a support shaft extending through the fan shaft, wherein the structural member extends from the support shaft to the nacelle and wherein the auxiliary power unit exhaust duct extends around the drive shaft and the support shaft through the structural member to the nacelle.

In certain exemplary embodiments the auxiliary power unit exhaust duct includes an exit portion that is located at a trailing edge of the nacelle.

In certain exemplary embodiments the structural member is an inlet guide vane.

In certain exemplary embodiments the aircraft includes a thermal insulation portion between the auxiliary power unit exhaust duct and the inlet guide vane.

In certain exemplary embodiments the aft engine is configured as a boundary layer ingestion fan.

In certain exemplary embodiments an auxiliary power unit exhaust flow through the auxiliary power unit exhaust duct within the nacelle is configured to de-ice the nacelle.

In certain exemplary embodiments the auxiliary power unit exhaust duct includes a first auxiliary power unit exhaust duct portion that extends around the drive shaft in a first direction through a first portion of the structural member to a first portion of the nacelle and a second auxiliary power unit exhaust duct portion that extends around the drive shaft in a second direction through a second portion of the structural member to a second portion of the nacelle, wherein the first auxiliary power unit exhaust duct portion and the second auxiliary power unit exhaust duct portion are bifurcated.

In another exemplary embodiment of the present disclosure, an aircraft extending between a forward end and an aft end is provided. The aircraft includes an auxiliary power unit positioned proximate the aft end of the aircraft, the auxiliary power unit having an auxiliary power unit inlet duct and an auxiliary power unit exhaust duct and a boundary layer ingestion fan positioned proximate the aft end of the aircraft between the aft end of the aircraft and the auxiliary power unit, the boundary layer ingestion fan spaced away from the auxiliary power unit, wherein the auxiliary power unit exhaust duct extends radially outward to a tail of the aircraft.

In certain exemplary embodiments the auxiliary power unit exhaust duct includes an exit portion that is located at a trailing edge of the tail of the aircraft.

In certain exemplary embodiments the auxiliary power unit exhaust duct extends radially outward to a vertical stabilizer of the aircraft.

In certain exemplary embodiments the auxiliary power unit exhaust duct extends around the boundary layer ingestion fan thereby an auxiliary power unit exhaust flow through the auxiliary power unit exhaust duct is prevented from interfering with the boundary layer ingestion fan.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a top view of an aircraft in accordance with an exemplary embodiment of the present disclosure.

FIG. 2 is a port side view of the exemplary aircraft of FIG. 1 in accordance with an exemplary embodiment of the present disclosure.

FIG. 3 is a schematic, cross-sectional view of a gas turbine engine mounted to the exemplary aircraft of FIG. 1 in accordance with an exemplary embodiment of the present disclosure.

FIG. 4 is a schematic, cross-sectional view of an auxiliary power unit in accordance with an exemplary embodiment of the present disclosure.

FIG. 5 is a schematic, cross-sectional view of an auxiliary power unit and boundary layer ingestion fan each positioned proximate the aft end of an aircraft in accordance with an exemplary embodiment of the present disclosure.

FIG. 6 is a close-up, schematic, cross-sectional view of an auxiliary power unit and boundary layer ingestion fan each positioned proximate the aft end of an aircraft in accordance with an exemplary embodiment of the present disclosure.

FIG. 7 is a schematic, cross-sectional view of an auxiliary power unit and boundary layer ingestion fan each positioned proximate the aft end of an aircraft with a bypass portion of an auxiliary power unit exhaust duct extending to the nacelle through a structural member in accordance with an exemplary embodiment of the present disclosure.

FIG. 8 is a schematic, cross-sectional view of an auxiliary power unit and boundary layer ingestion fan each positioned proximate the aft end of an aircraft with a motor having a drive shaft offset from a support shaft in accordance with an exemplary embodiment of the present disclosure.

FIG. 9 is a schematic, cross-sectional view of an auxiliary power unit and boundary layer ingestion fan each positioned proximate the aft end of an aircraft in accordance with another exemplary embodiment of the present disclosure.

FIG. 10 is a schematic, cross-sectional view of an auxiliary power unit and boundary layer ingestion fan each positioned proximate the aft end of an aircraft in accordance with another exemplary embodiment of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components. The terms “forward” and “aft” refer to the relative positions of a component based on an actual or anticipated direction of travel. For example, “forward” may refer to a front of an aircraft based on an anticipated direction of travel of the aircraft, and “aft” may refer to a back of the aircraft based on an anticipated direction of travel of the aircraft. The terms “upstream” and “downstream” refer to the relative direction with respect to fluid flow in a fluid pathway. For example, “upstream” refers to the direction from which the fluid flows, and “downstream” refers to the direction to which the fluid flows.

An aircraft of the present disclosure allows for the integration of an auxiliary power unit (APU) and a boundary layer ingestion (BLI) fan at the aft end of an aircraft. In an exemplary embodiment of the present disclosure, an auxiliary power unit exhaust duct of the APU extends through a portion of a support shaft of the BLI fan to enable the APU to be positioned proximate the aft end of the aircraft while also adding the BLI fan to a position proximate the aft end of the aircraft.

In another exemplary embodiment of the present disclosure, an auxiliary power unit exhaust duct of the APU extends through a structural member to a nacelle of an aft engine to enable the APU to be positioned proximate the aft end of the aircraft while also adding the BLI fan to a position proximate the aft end of the aircraft.

In another exemplary embodiment of the present disclosure, an auxiliary power unit exhaust duct of the APU extends radially outward to a tail of the aircraft to enable the APU to be positioned proximate the aft end of the aircraft while also adding the BLI fan to a position proximate the aft end of the aircraft. In this manner, the auxiliary power unit exhaust duct extends around the BLI fan thereby an auxiliary power unit exhaust flow through the auxiliary power unit exhaust duct is prevented from interfering with the boundary layer ingestion fan.

The embodiments of the present disclosure by allowing for the integration of the APU and the BLI fan at the aft end of an aircraft reduces the exhaust noise of the aircraft. Furthermore, embodiments of the present disclosure include a bypass portion of the auxiliary power unit exhaust duct that extends to the nacelle through the structural member, wherein an auxiliary power unit exhaust flow through the bypass portion to the nacelle is configured to de-ice the nacelle.

The embodiments of the present disclosure can also include temperature sensors at various locations of an integrated APU and BLI fan system. For example, in an exemplary embodiment, temperature sensors can be included at areas of the system to measure an air temperature just prior to fan blades of the BLI fan thereby allowing an increase or decrease of power to the fan based on such temperature readings. This configuration can prevent stalling of the BLI fan system.

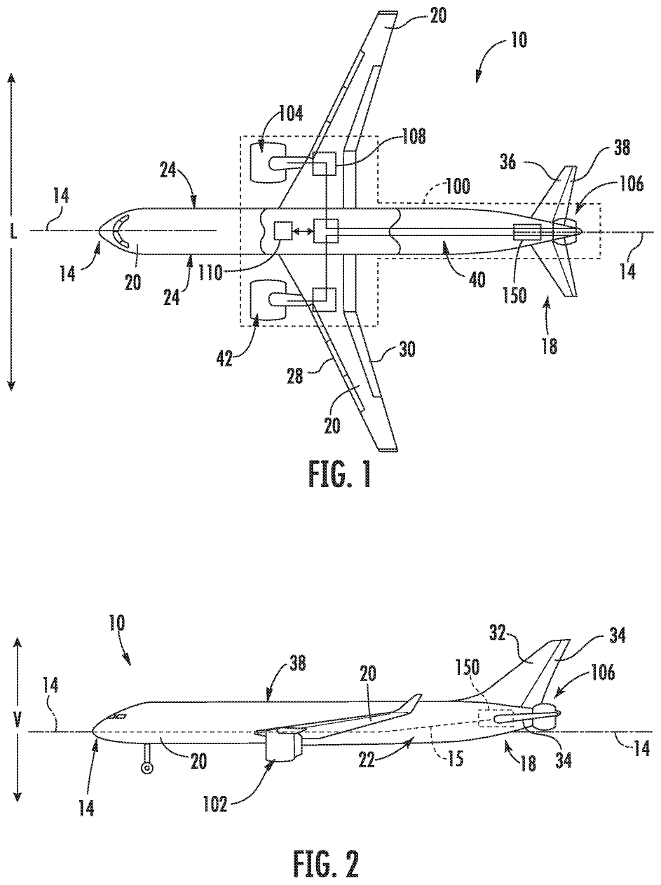

Referring now to the drawings, wherein identical numerals indicate the same elements throughout the figures, FIG. 1 provides a top view of an exemplary aircraft 10 as may incorporate various embodiments of the present invention. FIG. 2 provides a port side view of the aircraft 10 as illustrated in FIG. 1. As shown in FIGS. 1 and 2 collectively, the aircraft 10 defines a longitudinal centerline 14 that extends therethrough, a vertical direction V, a lateral direction L, a forward end 16, and an aft end 18. Moreover, the aircraft 10 defines a mean line 15 extending between the forward end 16 and aft end 18 of the aircraft 10. As used herein, the “mean line” refers to a midpoint line extending along a length of the aircraft 10, not taking into account the appendages of the aircraft 10 (such as the wings 20 and stabilizers discussed below).

Moreover, the aircraft 10 includes a fuselage 12, extending longitudinally from the forward end 16 of the aircraft 10 towards the aft end 18 of the aircraft 10, and a pair of wings 20. As used herein, the term “fuselage” generally includes all of the body of the aircraft 10, such as an empennage of the aircraft 10. The first of such wings 20 extends laterally outwardly with respect to the longitudinal centerline 14 from a port side 22 of the fuselage 12 and the second of such wings 20 extends laterally outwardly with respect to the longitudinal centerline 14 from a starboard side 24 of the fuselage 12. Each of the wings 20 for the exemplary embodiment depicted includes one or more leading edge flaps 26 and one or more trailing edge flaps 28. The aircraft 10 further includes a vertical stabilizer 30 having a rudder flap 32 for yaw control, and a pair of horizontal stabilizers 34, each having an elevator flap 36 for pitch control. The fuselage 12 additionally includes an outer surface or skin 38. It should be appreciated however, that in other exemplary embodiments of the present disclosure, the aircraft 10 may additionally or alternatively include any other suitable configuration of stabilizer that may or may not extend directly along the vertical direction V or horizontal/lateral direction L.

The exemplary aircraft 10 of FIGS. 1 and 2 includes a propulsion system 100, herein referred to as “system 100”. The exemplary system 100 includes a pair of aircraft engines, at least one of which mounted to each of the pair of wings 20, and an aft engine. For the embodiment depicted, the aircraft engines are configured as turbofan jet engines 102, 104 suspended beneath the wings 20 in an under-wing configuration. Additionally, the aft engine is configured as an engine configured to ingest and consume air forming a boundary layer over the fuselage 12 of the aircraft 10. Specifically, the aft engine is configured as a fan, i.e., a Boundary Layer Ingestion (BLI) fan 106, configured to ingest and consume air forming a boundary layer over the fuselage 12 of the aircraft 10. The BLI fan 106 is mounted to the aircraft 10 at a location aft of the wings 20 and/or the jet engines 102, 104, such that the mean line 15 extends therethrough. Specifically, for the embodiment depicted, the BLI fan 106 is fixedly connected to the fuselage 12 at the aft end 18, such that the BLI fan 106 is incorporated into or blended with a tail section at the aft end 18. However, it should be appreciated that in various other embodiments, some of which will be discussed below, the BLI fan 106 may alternatively be positioned at any suitable location of the aft end 18.

In various embodiments, the jet engines 102, 104 may be configured to provide power to an electric generator 108 and/or an energy storage device 110. For example, one or both of the jet engines 102, 104 may be configured to provide mechanical power from a rotating shaft (such as an LP shaft or HP shaft) to the electric generator 108. Additionally, the electric generator 108 may be configured to convert the mechanical power to electrical power and provide such electrical power to one or both of the energy storage device 110 or the BLI fan 106. Accordingly, in such an embodiment, the propulsion system 100 may be referred to as a gas-electric propulsion system. It should be appreciated, however, that the aircraft 10 and propulsion system 100 depicted in FIGS. 1 and 2 is provided by way of example only and that in other exemplary embodiments of the present disclosure, any other suitable aircraft 10 may be provided having a propulsion system 100 configured in any other suitable manner.

Moreover, it will be appreciated that the exemplary aircraft of FIGS. 1 and 2 includes an auxiliary power unit 150. For the embodiment depicted, the auxiliary power unit 150 is positioned proximate the aft end 18 of the aircraft 10 within the fuselage 12. The auxiliary power unit 150 may be provided for generating electrical power to operate or drive one or more aircraft systems. Additionally, or alternatively, the auxiliary power unit 150 may be configured to generate electrical power to, e.g., start one or more of the aircraft engines 102, 104.

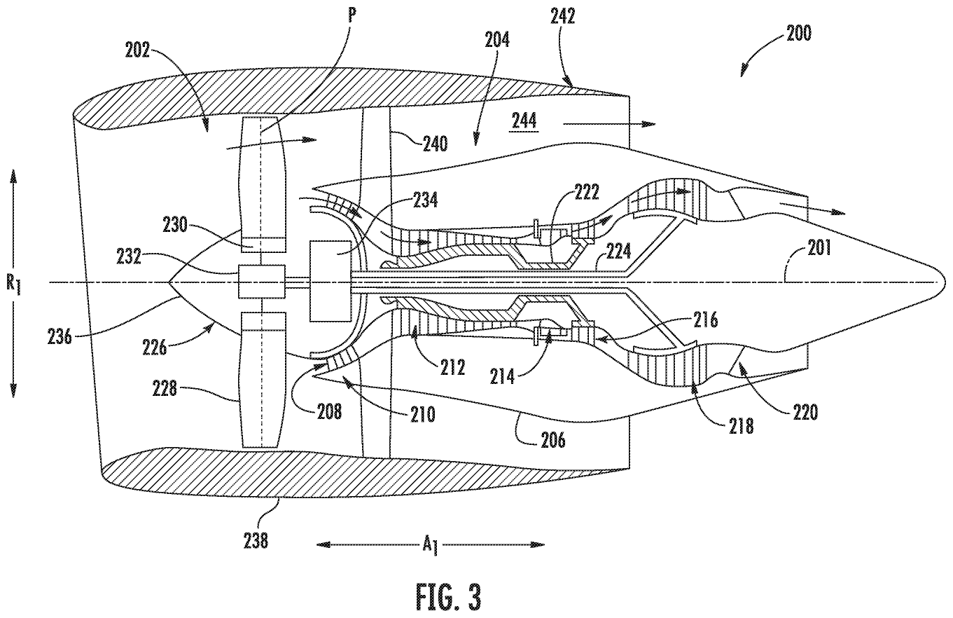

Referring now to FIG. 3, in at least certain embodiments, the jet engines 102, 104 may be configured as high-bypass turbofan jet engines. FIG. 3 is a schematic cross-sectional view of an exemplary high-bypass turbofan jet engine 200, herein referred to as “turbofan 200.” In various embodiments, the turbofan 200 may be representative of jet engines 102, 104. As shown in FIG. 3, the turbofan 200 defines an axial direction A1 (extending parallel to a longitudinal centerline or axis 201 provided for reference) and a radial direction R1. In general, the turbofan 200 includes a fan section 202 and a core turbine engine 204 disposed downstream from the fan section 202.

The exemplary core turbine engine 204 depicted generally includes a substantially tubular outer casing 206 that defines an annular inlet 208. The outer casing 206 encases, in serial flow relationship, a compressor section including a booster or low pressure (LP) compressor 210 and a high pressure (HP) compressor 212; a combustion section 214; a turbine section including a high pressure (HP) turbine 216 and a low pressure (LP) turbine 218; and a jet exhaust nozzle section 220. A high pressure (HP) shaft or spool 222 drivingly connects the HP turbine 216 to the HP compressor 212. A low pressure (LP) shaft or spool 224 drivingly connects the LP turbine 218 to the LP compressor 210.

For the embodiment depicted, the fan section 202 includes a variable pitch fan 226 having a plurality of fan blades 228 coupled to a disk 230 in a spaced apart manner. As depicted, the fan blades 228 extend outwardly from disk 230 generally along the radial direction R1. Each fan blade 228 is rotatable relative to the disk 230 about a pitch axis P by virtue of the fan blades 228 being operatively coupled to a suitable actuation member 232 configured to collectively vary the pitch of the fan blades 228 in unison. The fan blades 228, disk 230, and actuation member 232 are together rotatable about the longitudinal axis 201 by LP shaft 224 across a power gear box 234. The power gear box 234 includes a plurality of gears for stepping down the rotational speed of the LP shaft 224 to a more efficient rotational fan speed.

Referring still to the exemplary embodiment of FIG. 3, the disk 230 is covered by rotatable front hub 236 aerodynamically contoured to promote an airflow through the plurality of fan blades 228. Additionally, the exemplary fan section 202 includes an annular fan casing or outer nacelle 238 that circumferentially surrounds the fan 226 and/or at least a portion of the core turbine engine 204. It should be appreciated that the nacelle 238 may be configured to be supported relative to the core turbine engine 204 by a plurality of circumferentially-spaced outlet guide vanes 240. Moreover, a downstream section 242 of the nacelle 238 may extend over an outer portion of the core turbine engine 204 so as to define a bypass airflow passage 244 therebetween.

It should be appreciated, however, that the exemplary turbofan engine 200 depicted in FIG. 3 is by way of example only, and that in other exemplary embodiments, the turbofan engine 200 may have any other suitable configuration. Further, it should be appreciated, that in other exemplary embodiments, the jet engines 102, 104 may instead be configured as any other suitable aeronautical engine.

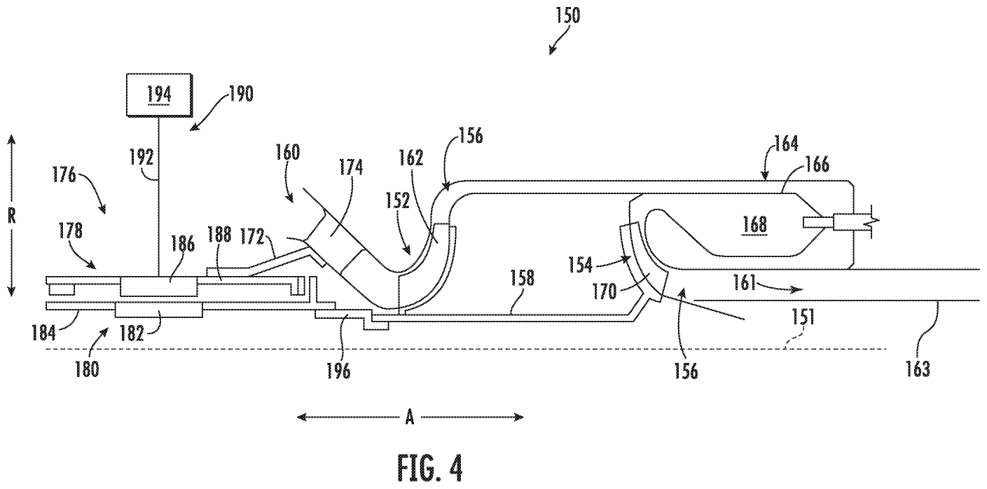

Referring now to FIG. 4, a close-up, schematic view of the exemplary auxiliary power unit 150 of FIGS. 1 and 2 is depicted. As will be appreciated, in an exemplary embodiment, the auxiliary power unit 150 is an engine, and more specifically, is a turbine engine defining an axial direction A, an axis 151 extending along the axial direction A, a radial direction R, and a circumferential direction (extending about the axis 151), and further including a compressor section and a turbine section. More specifically, for the embodiment depicted, the compressor section includes a compressor 152 and the turbine section includes a turbine 154. The compressor 152 and the turbine 154 together define at least in part a core air flowpath 156 of the auxiliary power unit 150. Further, the auxiliary power unit 150 includes a drive shaft 158, the drive shaft 158 coupled to at least one of the compressor 152 or the turbine 154, and more specifically, the drive shaft 158 extends between and couples the compressor 152 and the turbine 154. In such a manner the compressor 152 is rotatable with, and driven by, the turbine 154.

The auxiliary power unit 150 further defines an inlet 160 configured to receive a flow of air, which may be an ambient airflow from outside of the fuselage 12 of the aircraft 10. During operation of the auxiliary power unit 150, air flows from the inlet 160 to the compressor 152, where an impeller 162 of the compressor 152 (coupled to the drive shaft 158) compresses the flow of air. Moreover, the exemplary auxiliary power unit 150 includes a combustion section 164, with the exemplary combustion section 164 depicted including a reverse flow combustor 166. In such a manner, the compressed air from the compressor section flows around the combustor 166 before mixing with fuel and entering a combustion chamber 168 of the combustor 166, where the fuel-air mixture is combusted to generate combustion gases. The combustion gases flow through the turbine 154 of the turbine section, and more specifically, drive an impeller 170 of the turbine 154, rotating the turbine 154. Further, the drive shaft 158 is coupled to the impeller 170 of the turbine 154, such that rotation of the turbine 154 rotates/drives the drive shaft 158.

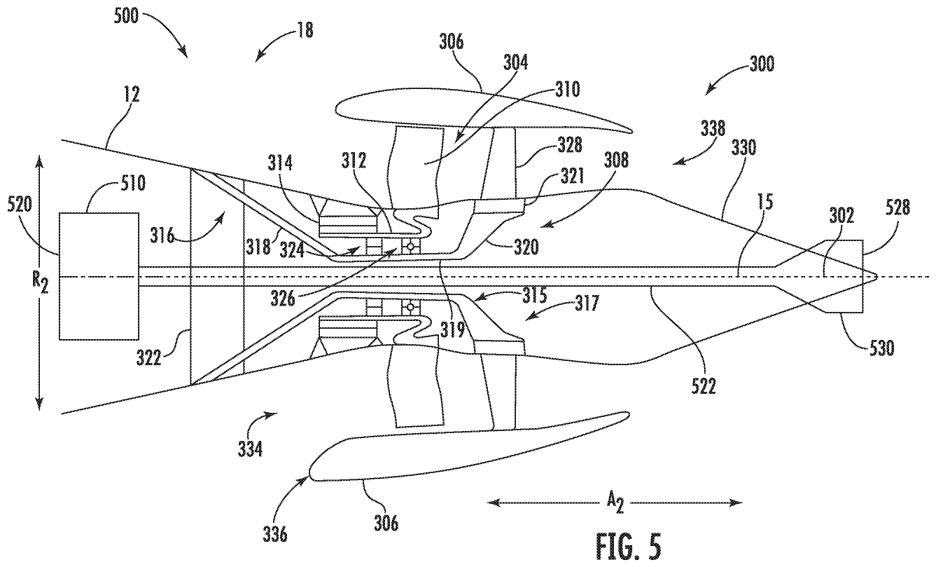

Referring still to FIG. 4, the auxiliary power unit 150 includes an auxiliary power unit exhaust duct 163 (see also FIGS. 5-8). Exhaust gases from the auxiliary power unit 150, e.g., an auxiliary power unit exhaust flow, flow out an outlet 161 and through the auxiliary power unit exhaust duct 163 (see also FIGS. 5-8).

Additionally, in one exemplary embodiment, the engine, or rather the auxiliary power unit 150, includes a stationary member and a rotating member. The rotating member is configured to rotate about the centerline axis 151 of the auxiliary power unit 150 during operation of the auxiliary power unit 150 with one or more of the compressor 152 or the turbine 154. By contrast, the stationary member is configured to remain stationary relative to the rotating member during operation of the auxiliary power unit 150. For the embodiment depicted, the rotating member is the drive shaft 158 of the auxiliary power unit 150, and the stationary member is a stationary support member 172. Notably, the stationary support member 172 is fixedly coupled to an inlet strut 174 positioned within the core air flowpath 156 of the auxiliary power unit 150, upstream of the compressor 152 of the compressor section of the auxiliary power unit 150. The stationary support member 172 (which may also be described as a stator assembly mount) may provide for electrical isolation of an electric machine 176. However, in other embodiments, the stationary member may be any other suitable component that remains stationary relative to the rotating member during operation of the auxiliary power unit 150.

Moreover, the exemplary auxiliary power unit 150 further includes an electric machine 176 positioned at a forward end thereof. The exemplary electric machine 176 generally includes a stator assembly 178 and a rotor assembly 180. Further, as is depicted schematically, the rotor assembly 180 generally includes a rotor 182 and a rotor shaft 184. Similarly, the stator assembly 178 generally includes a stator 186 and a stator shaft 188. The electric machine 176 may be configured as any suitable type of electric machine 176, such as an alternating current electric machine, a direct current electric machine, a permanent magnet electric machine, an induction electric machine, a brushed electric machine, etc. Accordingly, it will be appreciated that the stator 186, the rotor 182, or both, may include one or more permanent magnets, electromagnets, coils, etc.

Further, the electric machine 176 depicted is electrically coupled to an electric communication bus 190 through an electric line 192 of the electric communication bus 190. More specifically, the stator 186 of the electric machine 176 is electrically coupled to the electric line 192 of the electric communication bus 190. The electric communication bus may electrically connect the electric machine 176 to a power circuit of an aircraft, of a propulsion system, etc. The electric communication bus 190 further includes, for the embodiment depicted, a controller 194. The controller 194 may generally include power electronics, sensors, computers, processors, etc. In such a manner, the controller 194 may condition and/or direct the electrical power provided to the electric machine 176, the electrical power extracted from the electric machine 176, or both.

Moreover, the rotor assembly 180 is rotatable relative to the stator assembly 178 during operation of the auxiliary power unit 150. More specifically, the stator assembly 178 is coupled to the stationary member of the auxiliary power unit 150, and the rotor assembly 180 is coupled to, or otherwise rotatable with, the rotary component of the auxiliary power unit 150, which for the embodiment depicted is the drive shaft 158. Accordingly, when operated as an electric generator, the rotor assembly 180 of the electric machine 176 may be driven by the drive shaft 158 of the auxiliary power unit 150 to generate electrical power, also referred to as extracting power from the auxiliary power unit 150. By contrast, when operated as an electric motor, the rotor assembly 180 of the electric machine 176 may drive the drive shaft 158 of the auxiliary power unit 150 to, e.g., start the auxiliary power unit 150.

Regardless of the operating mode, the stator assembly 178 of the electric machine 176 may generate or receive electrical power having a relatively high-voltage, high levels of current, or both. In the event that, e.g., an insulation within the stator 186 of the stator assembly 178 breaks down or is otherwise insufficient to contain the electrical power, it may be possible for the electricity generated or received by the stator assembly 178 to connect to one or more electrically conductive components of the electric machine 176 through an electrical arc. In such a case, the electrical power may be conducted through, e.g., the rotor assembly 180 and to the drive shaft 158 of the auxiliary power unit 150. Once conducted to the drive shaft 158 of the auxiliary power unit 150, such electricity may flow through one or more relatively sensitive components, causing damage to such components (such as one or more bearings, sensors, etc.).

Accordingly, for the embodiment depicted, the auxiliary power unit 150 further includes an electrical break 196, with the drive shaft 158 being coupled to the rotor assembly 180 through the electrical break 196. Specifically, for the embodiment depicted, the rotor assembly 180 is coupled to the drive shaft 158 of the auxiliary power unit 150 solely through the electrical break 196, such that the electrical break 196 is configured to transfer substantially all of a torque between the drive shaft 158 in the rotor assembly 180 of the electric machine 176. For example, when operated as an electric motor, substantially all of the torque generated by the electric machine 176 is transferred from the rotor shaft 184 of the rotor assembly 180 of the electric machine 176 to the drive shaft 158 through the electrical break 196. Similarly, when operated as an electric generator, substantially all of the torque generated by the auxiliary power unit 150 (that is to be transferred to the electric machine 176) is transferred from the drive shaft 158 through the electrical break 196 to the rotor shaft 184 of the rotor assembly 180 of the electric machine 176.

In order to prevent electricity from being conducted from the rotor assembly 180 of the electric machine 176 to the drive shaft 158 of the auxiliary power unit 150, the electrical break 196 is formed substantially completely of a non-electrically conductive material. For example, in certain exemplary aspects, the non-electrically conductive material may be a plastic material, such as one or more of a polyethylene, polypropylene, polyvinyl chloride, acrylonitrile butadiene styrene, phenolics or phenol formaldehyde, polyetheretherketone, polyimide, etc.

Referring now to FIG. 5, a schematic, cross-sectional side view of an aft engine in accordance with various embodiments of the present disclosure is provided. The aft engine depicted is mounted to an aircraft 10 at an aft end 18 of the aircraft 10. Specifically, for the embodiment depicted, the aft engine is configured as a boundary layer ingestion (BLI) fan 300. As described herein, an aircraft of the present disclosure allows for the integration of an auxiliary power unit (APU) and a boundary layer ingestion (BLI) fan, i.e., a combined APU and BLI system 500, at the aft end 18 of an aircraft 10. Referring to FIGS. 5-8, in an exemplary embodiment of the present disclosure, an auxiliary power unit exhaust duct or outlet portion 522 of the APU 510 extends through a portion of a support shaft 315 of the BLI fan 300 to enable the APU 510 to be positioned proximate the aft end 18 of the aircraft 10 while also adding the BLI fan 300 to a position proximate the aft end 18 of the aircraft 10. In this manner, the BLI fan 300 together with an auxiliary power unit 510 forms a combined APU and BLI system 500 that both can be installed proximate the aft end 18 of the aircraft 10. The BLI fan 300 may be configured in substantially the same manner as the BLI fan 106 described above with reference to FIGS. 1 and 2 and the aircraft 10 may be configured in substantially the same manner as the exemplary aircraft 10 described above with reference to FIGS. 1 and 2. However, in other embodiments, the aft engine may instead be configured in any other suitable manner.

As shown in FIG. 5, the BLI fan 300 defines an axial direction A2 extending along a longitudinal centerline axis 302 that extends therethrough for reference, as well as a radial direction R2.

In general, the BLI fan 300 includes a fan 304 rotatable about the centerline axis 302, a nacelle 306 extending around a portion of the fan 304, and a structural support system 308. The fan 304 includes a plurality of fan blades 310 and a fan shaft 312. The plurality of fan blades 310 are attached to the fan shaft 312 and spaced generally along a circumferential direction of the turbofan engine.

In certain exemplary embodiments, the plurality of fan blades 310 may be attached in a fixed manner to the fan shaft 312, or alternatively, the plurality of fan blades 310 may be rotatably attached to the fan shaft 312. For example, the plurality of fan blades 310 may be attached to the fan shaft 312 such that a pitch of each of the plurality of fan blades 310 may be changed, e.g., in unison, by a pitch change mechanism (not shown). Changing the pitch of the plurality of fan blades 310 may increase an efficiency of the BLI fan 300 and/or may allow the BLI fan 300 to achieve a desired thrust profile. With such an exemplary embodiment, the BLI fan 300 may be referred to as a variable pitch BLI fan.

The fan shaft 312 is mechanically coupled to a power source 314 located at least partially within the fuselage 12 of the aircraft 10. In certain exemplary embodiments, the BLI fan 300 may be configured with a gas-electric propulsion system, such as the gas-electric propulsion system 100 described above with reference to FIG. 1. In such an embodiment, the power source 314 may be an electric motor that receives power from one or both of an energy storage device or an electric generator, e.g., such as the auxiliary power unit 150, the energy storage device 110, or electric generator 108 of FIGS. 1 and 2, the electric generator 108 converting mechanical power received from one or more under-wing mounted aircraft engines to electric power. Notably, the electric motor may be an inrunner electric motor, or alternatively may be an outrunner electric motor. In either embodiment, the electric motor may further include a gearbox mechanically coupling the electric motor to the fan shaft 312. Additionally, in still other exemplary embodiments, the power source 314 may instead be any other suitable power source. For example, the power source 314 may alternatively be configured as a gas engine, such as a gas turbine engine or internal combustion engine. Moreover, in certain exemplary embodiments, the power source 314 may be positioned at any other suitable location within, e.g., the fuselage 12 of the aircraft 10 or the BLI fan 300. For example, in certain exemplary embodiments, the power source 314 may be configured as a gas turbine engine positioned at least partially within the BLI fan 300.

As briefly stated above, the BLI fan 300 additionally includes a structural support system 308 for mounting the BLI fan 300 to the aircraft 10. The structural support system 308 extends generally from the fuselage 12 of the aircraft 10, through the fan shaft 312, and to the nacelle 306 of the BLI fan 300 when the BLI fan 300 is attached the aircraft 10. More specifically, the structural support system 308 generally includes a support shaft 315 extending between a first end 316 and a second end 317. Notably, as used herein, the term “support shaft” refers generally to any structural member, such as a support beam or rod. At the first end 316, the support shaft 315 is attached to the fuselage 12 of the aircraft 10 through a plurality of forward attachment arms 318 of the support shaft 315. For example, the plurality of forward attachment arms 318 of the support shaft 315 at the first end 316 of the support shaft 315 may be attached to a bulkhead 322 of the fuselage 12 of the aircraft 10.

The support shaft 315 extends from the first end 316, in the aft direction, through at least a portion of the fan shaft 312. For the embodiment depicted, the support shaft 315 includes a cylindrical body portion 319 extending through a center of the fan shaft 312—the cylindrical body portion 319 of the support shaft 315 being concentric with the fan shaft 312. Additionally, the cylindrical body portion 319 of the support shaft 315 supports rotation of the fan shaft 312. More particularly, for the embodiment depicted, a bearing assembly is provided between the body portion 319 of the support shaft 315 and the fan shaft 312. The exemplary bearing assembly depicted generally includes roller bearings 324 positioned forward of ball bearings 326. It should be appreciated, however, that in other embodiments, any other suitable bearing assembly may be provided between the support shaft 315 and the fan shaft 312. Alternatively, the fan shaft 312 may be supported for rotation in any other suitable manner, using any other suitable bearing assembly.

Referring still to FIG. 5, the structural support system 308 further includes one or more structural members 328 extending from the structural support shaft 315 to the nacelle 306. Specifically, for the embodiment depicted, the structural support shaft 315 includes a plurality of aft support arms 320 and a cylindrical support ring 321. The plurality of aft support arms 320 extend from the cylindrical body portion 319 of the support shaft 315 to the cylindrical support ring 321, and the one or more structural members 328 are attached to the cylindrical support ring 321. Additionally, for the embodiment depicted, the one or more structural members 328 include a plurality of circumferentially spaced structural members 328 attached to the second end 317 of the support shaft 315, i.e., to the cylindrical support ring 321. The one or more structural members 328 may provide structural support for the nacelle 306 and, e.g., a tail cone 330 of the BLI fan 300.

For the embodiment depicted in FIG. 5, the plurality of structural members 328 extend substantially along the radial direction R2 to the nacelle 306, to provide structural support for the nacelle 306. Additionally, although not depicted, the structural member 328 may, in certain embodiments, be evenly spaced along the circumferential direction. It should be appreciated, however, that the exemplary structural support system 308 depicted is provided by way of example only, and that in other exemplary embodiments, any other suitable structural support system 308 may be provided. For example, in other exemplary embodiments, the structural members 328 may instead define an angle relative to the radial direction R2, and further may be unevenly spaced along the circumferential direction. Additionally, the support shaft 315 may have any other suitable configuration. For example, in other exemplary embodiments, the support shaft 315 may be entirely formed of a cylindrical body portion, such that the cylindrical body portion mounts directly at a forward end to the fuselage 12 of the aircraft 10. Similarly, in other embodiments, the support shaft 315 may not include one or both of the aft attachment arms 320 or the cylindrical support ring 321. For example, in certain exemplary embodiments, the one or more structural members 328 may be attached directly to the cylindrical body portion 319 of the support shaft 315. Moreover, in still other embodiments, the support system 308 may include additional support features, e.g., static support features, positioned radially inward of the fan shaft 312 and, e.g., within the support shaft 315, or elsewhere for providing a desired amount of support for the structural member 328 and nacelle 306.

Notably, referring still to embodiment of FIG. 5, the one or more structural members 328 are attached to the nacelle 306, and extend from the support shaft 315 to the nacelle 306, at a location aft of the plurality of fan blades 310. The one or more structural members 328 may include a plurality of structural members 328 extending substantially along the radial direction R2, as is depicted, and substantially evenly spaced along the circumferential direction of the BLI fan 300. For example, the one or more structural members 328 may include three or more structural members 328, five or more structural members 328, eight or more structural members 328, or twelve or more structural members 328. However, in other exemplary embodiments, the one or more structural members 328 may include any other suitable number of structural members 328, and may define any suitable angle with the longitudinal centerline 302. Additionally, in other exemplary embodiments, the one or more structural members 328 may be spaced in any suitable configuration along the circumferential direction. It should be appreciated, that as used herein, terms of approximation, such as “approximately,” “substantially,” or “about,” refer to being within a ten percent margin of error.

Moreover, in at least certain exemplary embodiments, the one or more structural members 328 may each be configured as an outlet guide vane. If configured as outlet guide vanes, the one or more structural members 328 may be configured for directing a flow of air through the BLI fan 300. Additionally, with such configuration, the one or more structural members 328 may be configured as fixed outlet guide vanes, or alternatively as variable outlet guide vanes. For example, each of the one or more structural members 328 may include a flap (not shown) positioned at an aft end rotatable about a substantially radial axis to vary a direction in which the structural member (configured as an outlet guide vane) directs the flow of air.

Aft of the plurality of fan blades 310 and aft of the one or more structural members 328 of the structural support system 308, the BLI fan 300 additionally defines a nozzle 338 between the nacelle 306 and the tail cone 330. The nozzle 338 may be configured to generate an amount of thrust from the air flowing therethrough, and the tail cone 330 may be shaped to minimize an amount of drag on the BLI fan 300. However, in other embodiments, the tail cone 330 may have any other shape and may, e.g., end forward of an aft end of the nacelle 306 such that the tail cone 330 is enclosed by the nacelle 306 at an aft end. Additionally, in other embodiments, the BLI fan 300 may not be configured to generate any measurable amount of thrust, and instead may be configured to ingest air from a boundary layer of air of the fuselage 12 of the aircraft 10 and add energy/speed up such air to reduce an overall drag on the aircraft 10 (and thus increase a net thrust of the aircraft 10).

Referring still to FIG. 5, the BLI fan 300 defines an inlet 334 at the forward end 336 of the BLI fan 300, between the nacelle 306 and the fuselage 12 of the aircraft 10. The nacelle 306 of the BLI fan 300 extends around the mean line 15 of the aircraft 10 and the fuselage 12 of the aircraft 10 at the aft end 18 of the aircraft 10. Specifically, for the embodiment depicted, the inlet 334 of the BLI fan 300 extends substantially three hundred sixty degrees in the circumferential direction around the mean line 15 of the aircraft 10 and the fuselage 12 of the aircraft 10 when, such as in the embodiment depicted, the BLI fan 300 is mounted to the aircraft 10.

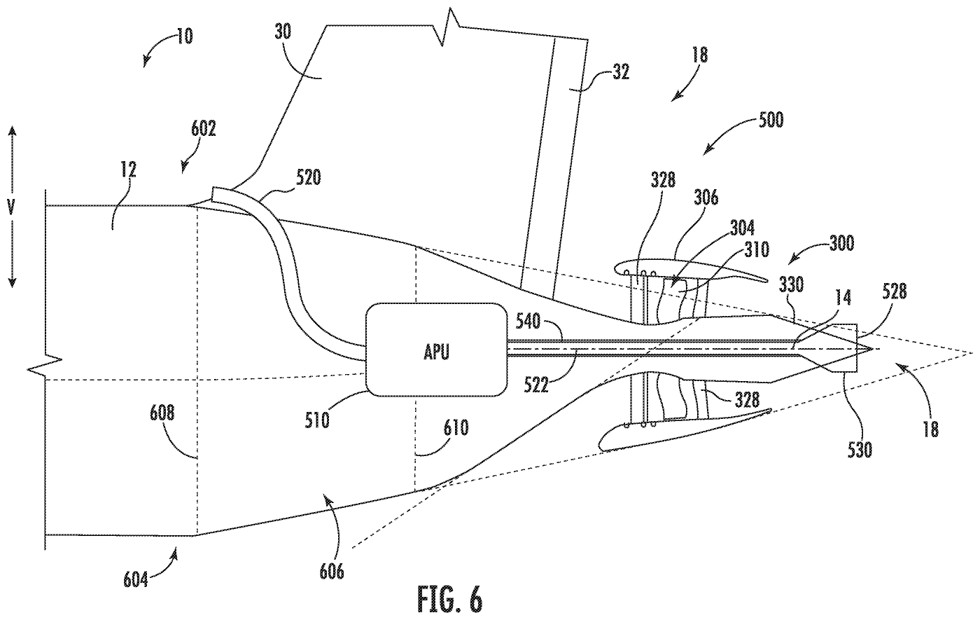

Referring now to FIG. 6, a close-up view is provided of the aft end 18 of the exemplary aircraft 10 described above with reference to FIGS. 1, 2, and 5. As discussed above, the fuselage 12 of the aircraft 10 extends generally from the forward end 16 of the aircraft 10 towards the aft end 18 of the aircraft 10, with the aft engine or BLI fan 300 and the APU 510 mounted to the fuselage 12 proximate the aft end 18 of the aircraft 10. The fuselage 12 defines a top side 602 and a bottom side 604 along the vertical direction V. Moreover, the exemplary fuselage 12 depicted defines a frustum 606 located proximate the aft end 18 of the aircraft 10. Specifically, for the embodiment depicted, the frustum 606 is positioned aft of the pair of wings 20 (FIGS. 1 and 2) of the aircraft 10. As used herein, the term “frustum” refers generally to a portion of a shape lying between two parallel planes. Accordingly, for the embodiment depicted, the frustum 606 is defined between a first, or forward plane 608 and a second, or aft plane 610, the forward and aft planes 608, 610 being parallel to one another and perpendicular to the longitudinal centerline 14 of the aircraft 10 (FIGS. 1 and 2). Referring to FIG. 6, as discussed above, the aircraft 10 includes a vertical stabilizer 30 having a rudder flap 32 for yaw control.

FIGS. 5-8 illustrate exemplary embodiments of the present disclosure. Referring to FIGS. 5-8, a combined APU and BLI system 500 for an aircraft 10 extending between a forward end 16 and an aft end 18 will now be described. As shown in FIGS. 5-8, the present disclosure allows for the installation of a combined APU and BLI system 500 proximate the aft end 18 of the aircraft 10.

Referring to FIGS. 5 and 6, in an exemplary embodiment, the APU and BLI system 500 includes an auxiliary power unit 510 positioned proximate the aft end 18 of the aircraft 10 and also a boundary layer ingestion fan 300 positioned proximate the aft end 18 of the aircraft 10. The auxiliary power unit 510 includes an auxiliary power unit inlet duct or inlet 520 and an auxiliary power unit exhaust duct or outlet portion 522. The boundary layer ingestion fan 300 includes a support shaft 315 as described in detail above. As shown in FIGS. 5 and 6, in an exemplary embodiment, the auxiliary power unit exhaust duct 522 extends through a portion of the support shaft 315 of the boundary layer ingestion fan 300. In one embodiment, the auxiliary power unit exhaust duct 522 extends through a center of the support shaft 315 of the boundary layer ingestion fan 300 along an axial direction of the boundary layer ingestion fan 300, e.g., longitudinal centerline axis 302. In one embodiment, the auxiliary power unit 510 corresponds to the auxiliary power unit 150 as described above with respect to FIG. 4. As shown in FIGS. 5 and 6, an exit portion 528 of the auxiliary power unit exhaust duct 522 allows for exhaust air to be exhausted or exited to atmosphere.

Referring to FIG. 6, in one embodiment, the inlet duct 520 of the auxiliary power unit 510 is positioned at a top side 602 of the fuselage and extends towards a central portion of the frustum 606 of the fuselage 12 to the auxiliary power unit 510. Furthermore, the exhaust duct or outlet duct 522 of the auxiliary power unit 510 extends out from the auxiliary power unit 510 and through a portion of the support shaft 530 of the boundary layer ingestion fan 512.

In one embodiment, a portion of the boundary layer ingestion fan 512 makes up the aft end 18 of the aircraft 10 as shown in FIGS. 5 and 6. For example, as shown in FIGS. 5 and 6, the boundary layer ingestion fan 512 is incorporated into a tail section or tail cone 330 at the aft end 18 of the aircraft 10.

Referring to FIGS. 5-8, in an exemplary embodiment, the APU and BLI system 500 includes a mixer 530 in communication with the auxiliary power unit 510 and the boundary layer ingestion fan 300 such that the mixer 530 receives and mixes a boundary layer airflow from the boundary layer ingestion fan 300 and an auxiliary power unit exhaust flow from the auxiliary power unit exhaust duct 522. In this manner, the mixer 530 of the present disclosure provides noise reduction for the APU 510 and/or other components of the aircraft 10 by mixing the boundary layer airflow and the auxiliary power unit exhaust flow.

In one embodiment, the mixer 530 is formed at the aft-most portion of the tail cone 330 and is in communication with an outlet of the auxiliary power unit exhaust duct 522. In one embodiment, the mixer 530 comprises a fluted mixer. In another embodiment, the mixer 530 comprises a chevron mixer. In other embodiments, the mixer 530 comprises other mixer mechanisms for mixing two separate flows therein.

Referring to FIG. 6, in an exemplary embodiment, the APU and BLI system 500 includes a thermal insulation portion 540 between the auxiliary power unit exhaust duct 522 and the support shaft 315 of the boundary layer ingestion fan 300. In this manner, the BLI fan 300 is thermally insulated from higher temperatures of the auxiliary power unit exhaust flow exiting the auxiliary power unit exhaust duct 522.

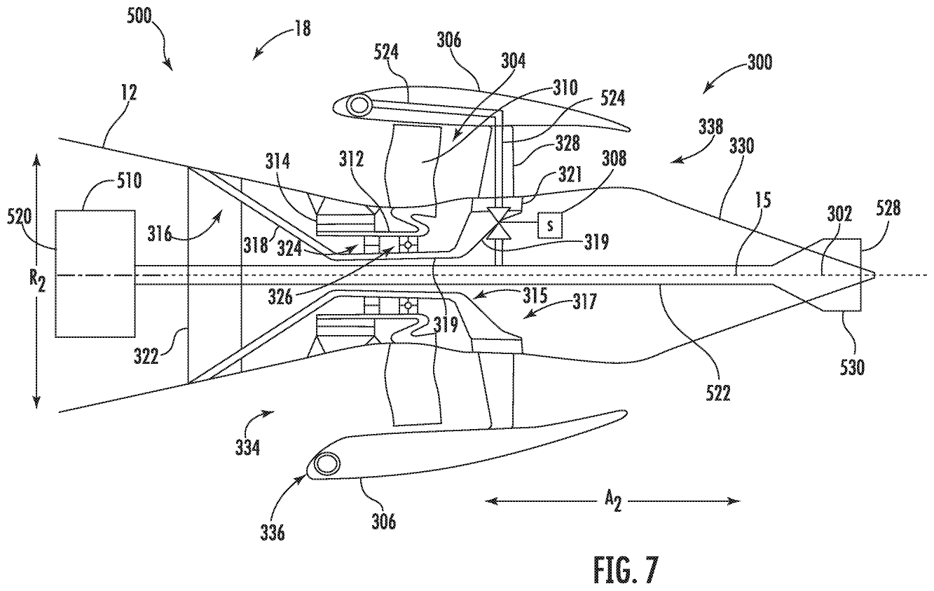

Referring to FIG. 7, in an exemplary embodiment, the APU and BLI system 500 includes a mechanism for de-icing the nacelle 306 of the boundary layer ingestion fan 300. For example, the auxiliary power unit exhaust duct 522 includes a bypass portion 524 that extends to the nacelle 306 through the structural member 328. In this manner, the higher temperatures of an auxiliary power unit exhaust flow traveling through the bypass portion 524 to the nacelle 306 is configured to de-ice the nacelle 306. Essentially the bypass portion 524 allows some of the auxiliary power unit exhaust flow to be routed from the auxiliary power unit exhaust duct 522 to a portion of the nacelle 306 thereby providing de-ice capabilities using this configuration of the bypass portion 524. As shown in FIG. 7, the bypass portion 524 can extend to a front edge of the nacelle 306. Other configurations of the bypass portion 524 through all areas of the nacelle 306 are contemplated, e.g., extending from the front edge to a rear edge of the nacelle 306.

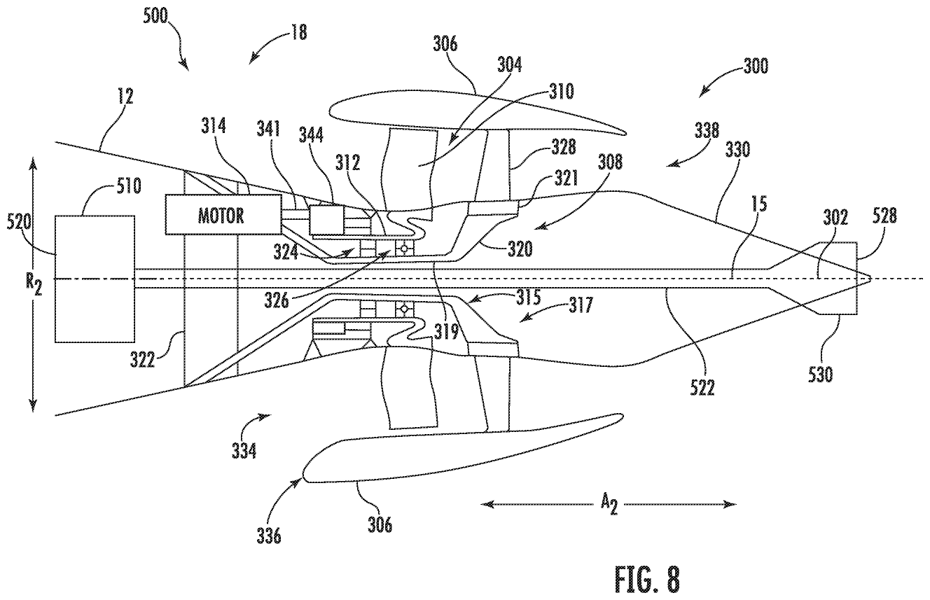

Referring to FIG. 8, in an exemplary embodiment, the APU and BLI system 500 includes a BLI fan 300 having a motor or power source 314 having a drive shaft 341 that is offset from the fan shaft 312. In this configuration, the BLI fan 300 also includes a gear 344 that is in communication with the drive shaft 341 and the fan shaft 312 to drive the BLI fan 300. In one embodiment, the gear 344 comprises a ring gear, a single helix, a double helix, a spur gear, or other gear mechanism to allow an offset drive shaft 341 to drive the fan shaft 312 of the BLI fan 300. It is contemplated that in some embodiments, the power source or motor 314 drives a gear 344 and in some embodiments the power source or motor 314 is a ring motor.

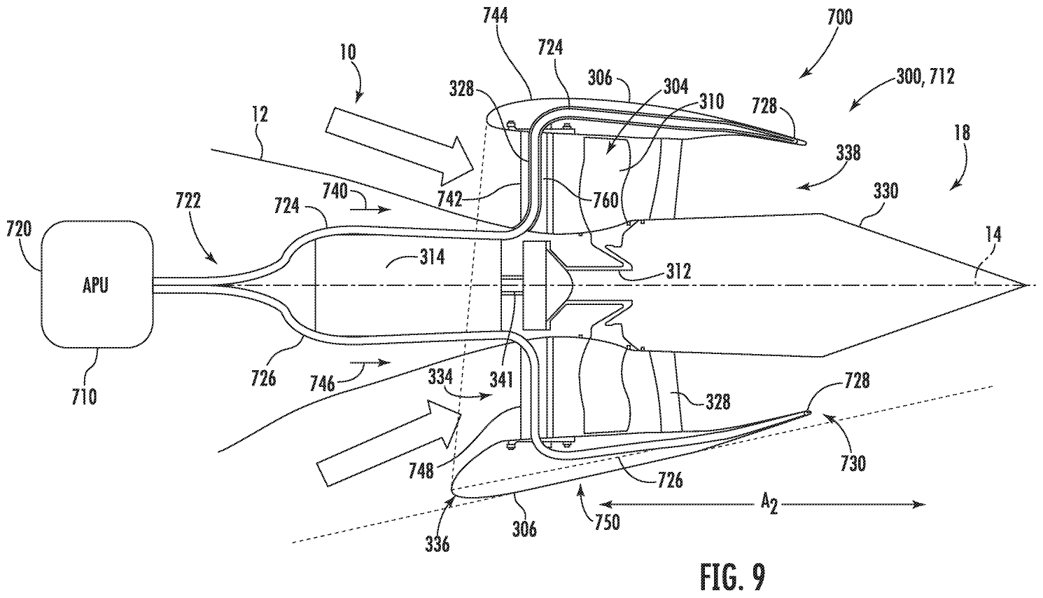

FIG. 9 illustrates another exemplary embodiment of the present disclosure. Referring to FIG. 9, a combined APU and BLI system 700 for an aircraft 10 extending between a forward end 16 and an aft end 18 will now be described. As shown in FIG. 9, the present disclosure allows for the installation of a combined APU and BLI system 700 proximate the aft end 18 of the aircraft 10.

Referring to FIG. 9, in an exemplary embodiment, the APU and BLI system 700 includes an auxiliary power unit 710 positioned proximate the aft end 18 of the aircraft 10 and also an aft engine or boundary layer ingestion fan 712 positioned proximate the aft end 18 of the aircraft 10. The auxiliary power unit 710 includes an auxiliary power unit inlet duct or inlet 720 and an auxiliary power unit exhaust duct or outlet portion 722.

In one embodiment, the aft engine or boundary layer ingestion fan 712 corresponds to the aft engine or boundary layer ingestion fan 300 as described above with respect to FIG. 5. As described herein, the aft engine is configured as a boundary layer ingestion fan 300, 712.

Referring to FIG. 9, in an exemplary embodiment of the present disclosure, the auxiliary power unit exhaust duct 722 of the APU 710 extends through a structural member 328 to a nacelle 306 of an aft engine or BLI fan 712 to enable the APU to be positioned proximate the aft end 18 of the aircraft 10 while also adding the BLI fan 712 to a position proximate the aft end 18 of the aircraft 10. Referring to FIG. 9, in one embodiment, the auxiliary power unit exhaust duct 722 extends around the drive shaft 341 and the support shaft 315 through the structural member 328 to the nacelle 306.

Referring to FIG. 9, in an exemplary embodiment, the auxiliary power unit exhaust duct 722 of the APU 710 includes a first auxiliary power unit exhaust duct portion 724 and a second auxiliary power unit exhaust duct portion 726. In one embodiment, the first auxiliary power unit exhaust duct portion 724 extends around the drive shaft 341 in a first direction 740 through a first portion 742 of the structural member 328 to a first portion 744 of the nacelle 306. Furthermore, the second auxiliary power unit exhaust duct portion 726 extends around the drive shaft 341 in a second direction 746 through a second portion 748 of the structural member 328 to a second portion 750 of the nacelle 306. As shown in FIG. 9, the first auxiliary power unit exhaust duct portion 724 and the second auxiliary power unit exhaust duct portion 726 are bifurcated. In this manner, the auxiliary power unit exhaust duct 722 extends around the BLI fan 712 thereby an auxiliary power unit exhaust flow through the auxiliary power unit exhaust duct 722 is prevented from interfering with the boundary layer ingestion fan 712.

In this manner, referring to FIG. 9, in an exemplary embodiment, the APU and BLI system 700 by including a first auxiliary power unit exhaust duct portion 724 and a second auxiliary power unit exhaust duct portion 726 that extend through structural members 328 to the nacelle 306 provides a mechanism for de-icing the nacelle 306 of the boundary layer ingestion fan 712. In this manner, the higher temperatures of an auxiliary power unit exhaust flow traveling through the first auxiliary power unit exhaust duct portion 724 and the second auxiliary power unit exhaust duct portion 726 to different portions of the nacelle 306 are configured to de-ice the nacelle 306. Essentially the first auxiliary power unit exhaust duct portion 724 and the second auxiliary power unit exhaust duct portion 726 allow some of the auxiliary power unit exhaust flow to be routed from the auxiliary power unit exhaust duct 722 to portions of the nacelle 306 thereby providing de-ice capabilities using this configuration of the auxiliary power unit exhaust duct 722. As shown in FIG. 9, the first auxiliary power unit exhaust duct portion 724 and the second auxiliary power unit exhaust duct portion 726 can extend to all portions of a nacelle 306.

In one embodiment, the auxiliary power unit exhaust duct 722 includes an exit portion 728 that is located at a trailing edge 730 of the nacelle 306. In one embodiment, the first auxiliary power unit exhaust duct portion 724 and the second auxiliary power unit exhaust duct portion 726 provide two separate exit portions 728 located at a trailing edge 730 of the nacelle 306.

In an exemplary embodiment, the structural member 328 that the auxiliary power unit exhaust duct 722 of the APU 710 extends through is a guide vane of the BLI fan or aft engine 712. By exhausting through guide vanes or structural members 328 of the BLI fan 712, e.g., inlet guide vanes, the combined APU and BLI system 700 provides a radially consistent temperature profile to the fan blades 310. It is contemplated that the auxiliary power unit exhaust duct 722 of the APU 710 can extend through any component of the BLI fan or aft engine 712 such as inlet guide vanes, outlet guide vanes, or other components of the BLI fan or aft engine 712.

Referring to FIG. 9, in an exemplary embodiment, the APU and BLI system 700 includes a thermal insulation portion 760 between the auxiliary power unit exhaust duct 722 and the structural member 328, e.g., a guide vane of the aft engine or BLI fan 712. In this manner, the BLI fan 712 is thermally insulated from higher temperatures of the auxiliary power unit exhaust flow exiting the auxiliary power unit exhaust duct 722.

In one embodiment, the auxiliary power unit 710 corresponds to the auxiliary power unit 150 as described above with respect to FIG. 4. As shown in FIG. 9, an exit portion of the auxiliary power unit exhaust duct 722 allows for exhaust air to be exhausted or exited to atmosphere.

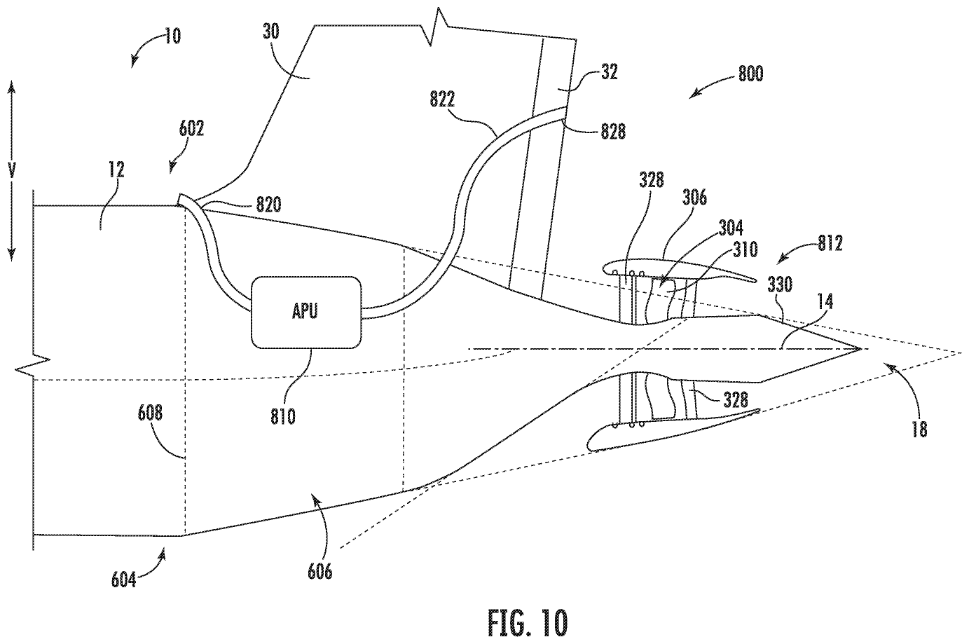

FIG. 10 illustrates another exemplary embodiment of the present disclosure. Referring to FIG. 10, a combined APU and BLI system 800 for an aircraft 10 extending between a forward end 16 and an aft end 18 will now be described. As shown in FIG. 10, the present disclosure allows for the installation of a combined APU and BLI system 800 proximate the aft end 18 of the aircraft 10.

Referring to FIG. 10, in an exemplary embodiment, the APU and BLI system 800 includes an auxiliary power unit 810 positioned proximate the aft end 18 of the aircraft 10 and also an aft engine or boundary layer ingestion fan 812 positioned proximate the aft end 18 of the aircraft 10. The auxiliary power unit 810 includes an auxiliary power unit inlet duct or inlet 820 and an auxiliary power unit exhaust duct or outlet portion 822.

In one embodiment, the aft engine or boundary layer ingestion fan 812 corresponds to the aft engine or boundary layer ingestion fan 300 as described above with respect to FIG. 5. As described herein, the aft engine is configured as a boundary layer ingestion fan 300, 812.

Referring to FIG. 10, in an exemplary embodiment, the boundary layer ingestion fan 812 is spaced away from the auxiliary power unit 810 with each being positioned proximate the aft end 18 of the aircraft 10. The auxiliary power unit exhaust duct 822 extends radially outward to a tail of the aircraft 10, e.g., the auxiliary power unit exhaust duct 822 extends radially outward to a vertical stabilizer 30 of the aircraft 10 as shown in FIG. 10. In one embodiment, the auxiliary power unit exhaust duct 822 includes an exit portion 828 that is located at a trailing edge, e.g., at a trailing edge of rudder flap 32, of the tail of the aircraft 10 as shown in FIG. 10.

Referring to FIG. 10, in an exemplary embodiment of the present disclosure, the auxiliary power unit exhaust duct 822 of the APU 810 extending radially outward to a tail of the aircraft 10, e.g., to vertical stabilizer 30, enables the APU 810 to be positioned proximate the aft end 18 of the aircraft 10 while also adding the BLI fan 812 to a position proximate the aft end 18 of the aircraft 10. In this manner, the auxiliary power unit exhaust duct 822 extends around the BLI fan 812 and thereby an auxiliary power unit exhaust flow through the auxiliary power unit exhaust duct 822 is prevented from interfering with the operation of the boundary layer ingestion fan 812.

An aircraft of the present disclosure allows for the integration of an auxiliary power unit (APU) and a boundary layer ingestion (BLI) fan at the aft end of an aircraft. The embodiments of the present disclosure by allowing for the integration of the APU and the BLI fan at the aft end of an aircraft reduces the exhaust noise of the aircraft. Furthermore, embodiments of the present disclosure include a bypass portion of the auxiliary power unit exhaust duct that extends to the nacelle through the structural member, wherein an auxiliary power unit exhaust flow through the bypass portion to the nacelle is configured to de-ice the nacelle.

The embodiments of the present disclosure can also include temperature sensors at various locations of an integrated APU and BLI fan system. For example, in an exemplary embodiment, temperature sensors can be included at areas of the system to measure an air temperature just prior to fan blades of the BLI fan thereby allowing an increase or decrease of power to the fan based on such temperature readings. This configuration can prevent stalling of the BLI fan system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. An aircraft extending between a forward end and an aft end, the aircraft comprising:
an auxiliary power unit positioned proximate the aft end of the aircraft, the auxiliary power unit having an auxiliary power unit inlet duct and an auxiliary power unit exhaust duct; and
a boundary layer ingestion fan positioned proximate the aft end of the aircraft, the boundary layer ingestion fan having a support shaft,
wherein the auxiliary power unit exhaust duct extends through a portion of the support shaft of the boundary layer ingestion fan.

2. The aircraft of claim 1, further comprising a mixer in communication with the auxiliary power unit and the boundary layer ingestion fan such that the mixer receives and mixes a boundary layer airflow from the boundary layer ingestion fan and an auxiliary power unit exhaust flow from the auxiliary power unit exhaust duct.

3. The aircraft of claim 1, further comprising:
a thermal insulation portion between the auxiliary power unit exhaust duct and the support shaft of the boundary layer ingestion fan.

4. The aircraft of claim 1, wherein the boundary layer ingestion fan defines a central axis and further comprises:
a fan rotatable about the central axis and including a plurality of fan blades attached to a fan shaft;
a nacelle encircling the plurality of fan blades; and
a structural member extending from the support shaft of the boundary layer ingestion fan to the nacelle.

5. The aircraft of claim 4, wherein the auxiliary power unit exhaust duct includes a bypass portion that extends to the nacelle through the structural member, wherein an auxiliary power unit exhaust flow through the bypass portion to the nacelle is configured to de-ice the nacelle.

6. The aircraft of claim 4, further comprising:
a motor having a drive shaft offset from the fan shaft; and
a gear in communication with the drive shaft and the fan shaft to drive the boundary layer ingestion fan.

7. The aircraft of claim 1, wherein the auxiliary power unit exhaust duct extends through a center of the support shaft of the boundary layer ingestion fan along an axial direction of the boundary layer ingestion fan.

8. The aircraft of claim 1, wherein the boundary layer ingestion fan is incorporated into a tail section of the aircraft at the aft end of the aircraft.

9. The aircraft of claim 1, wherein a portion of the boundary layer ingestion fan makes up the aft end of the aircraft.

10. An aircraft extending between a forward end and an aft end, the aircraft comprising:
an auxiliary power unit positioned proximate the aft end of the aircraft, the auxiliary power unit having an auxiliary power unit inlet duct and an auxiliary power unit exhaust duct; and
an aft engine configured to be mounted to the aircraft at the aft end, the aft engine defining a central axis and comprising:
a fan rotatable about the central axis of the aft engine and including a plurality of fan blades attached to a fan shaft;
a nacelle encircling the plurality of fan blades; and
a structural member extending from a portion of the aft engine to the nacelle;
wherein the auxiliary power unit exhaust duct extends through the structural member to the nacelle.

11. The aircraft of claim 10, wherein the aft engine further comprises:
a power source having a drive shaft; and
a support shaft extending through the fan shaft,
wherein the structural member extends from the support shaft to the nacelle, and
wherein the auxiliary power unit exhaust duct extends around the drive shaft and the support shaft through the structural member to the nacelle.

12. The aircraft of claim 10, wherein the auxiliary power unit exhaust duct includes an exit portion that is located at a trailing edge of the nacelle.

13. The aircraft of claim 10, wherein the structural member is an inlet guide vane.

14. The aircraft of claim 13, further comprising:
a thermal insulation portion between the auxiliary power unit exhaust duct and the inlet guide vane.

15. The aircraft of claim 10, wherein the aft engine is configured as a boundary layer ingestion fan.

16. The aircraft of claim 10, wherein an auxiliary power unit exhaust flow through the auxiliary power unit exhaust duct within the nacelle is configured to de-ice the nacelle.

17. The aircraft of claim 11, wherein the auxiliary power unit exhaust duct comprises:
a first auxiliary power unit exhaust duct portion that extends around the drive shaft in a first direction through a first portion of the structural member to a first portion of the nacelle; and
a second auxiliary power unit exhaust duct portion that extends around the drive shaft in a second direction through a second portion of the structural member to a second portion of the nacelle,
wherein the first auxiliary power unit exhaust duct portion and the second auxiliary power unit exhaust duct portion are bifurcated.

18. An aircraft extending between a forward end and an aft end, the aircraft comprising:
an auxiliary power unit positioned proximate the aft end of the aircraft, the auxiliary power unit having an auxiliary power unit inlet duct and an auxiliary power unit exhaust duct; and
a boundary layer ingestion fan positioned proximate the aft end of the aircraft between the aft end of the aircraft and the auxiliary power unit, the boundary layer ingestion fan spaced away from the auxiliary power unit,
wherein the auxiliary power unit exhaust duct extends radially outward to a tail of the aircraft.

19. The aircraft of claim 18, wherein the auxiliary power unit exhaust duct includes an exit portion that is located at a trailing edge of the tail of the aircraft.

20. The aircraft of claim 18, wherein the auxiliary power unit exhaust duct extends radially outward to a vertical stabilizer of the aircraft.
